(19) United States
(12) Patent Application Publication
(10) Pub. No.: US 2019/0349758 A1
(43) Pub. Date: Nov. 14, 2019

(54) ULTRASOUND-ASSISTED WI-FI AND BLUETOOTH AUTHENTICATION

(71) Applicants: Jing Zhu, Portland, OR (US); Xintian Lin, Palo Alo, CA (US)

(72) Inventors: Jing Zhu, Portland, OR (US); Xintian Lin, Palo Alo, CA (US)

(21) Appl. No.: 16/409,590

(22) Filed: May 10, 2019

Related U.S. Application Data
(60) Provisional application No. 62/669,711, filed on May 10, 2018.
(60) Provisional application No. 62/672,160, filed on May 16, 2018.

(51) Int. Cl. H04W 12/00; H04L 29/06; H04W 76/14; H04W 76/15

(52) U.S. Cl. CPC H04W 12/00504; H04L 63/18; H04W 76/15; H04W 76/14; H04L 63/083

(57) ABSTRACT

This disclosure describes systems, methods, and devices related to ultrasound-enabled Wi-Fi and Bluetooth authentication. A device may identify an ultrasound message received from a station device, the ultrasound message including a subset of characters associated with a wireless connection. The device may determine, based on the subset of characters, an identifier associated with the wireless connection. The device may determine, based on the ultrasound message, a password associated with the wireless connection. The device may establish the wireless connection using the identifier and the password.

### CROSS-REFERENCE TO RELATED APPLICATIONS

This application claims the benefit of U.S. Provisional Application No. 62/665,711, filed May 10, 2018, and of U.S. Provisional Application No. 62/672,160 filed May 16, 2018, the disclosures of which are incorporated by reference as if set forth in full.

### TECHNICAL FIELD

This disclosure generally relates to systems and methods for wireless communications and, more particularly, to ultrasound-assisted Wi-Fi and Bluetooth device authentication.

### BACKGROUND

Wireless devices are becoming widely prevalent and are increasingly requesting access to wireless channels. The Institute of Electrical and Electronics Engineers (IEEE) is developing one or more standards that define device authentication procedures.

### BRIEF DESCRIPTION OF THE DRAWINGS

FIG. 1 is a network diagram illustrating an example network environment, in accordance with one or more example embodiments of the present disclosure.

FIG. 2A depicts an illustrative portion of an ultrasound frame format, in accordance with one or more example embodiments of the present disclosure.

FIG. 2B depicts an illustrative sequence of ultrasound-assisted Wi-Fi authentication, in accordance with one or more example embodiments of the present disclosure.

FIG. 3 depicts an illustrative sequence of ultrasound-assisted device authentication, in accordance with one or more example embodiments of the present disclosure.

FIG. 4A illustrates a flow diagram of illustrative process for ultrasound-assisted Wi-Fi and Bluetooth device authentication, in accordance with one or more example embodiments of the present disclosure.

FIG. 4B illustrates a flow diagram of illustrative process for ultrasound-assisted Wi-Fi and Bluetooth device authentication, in accordance with one or more example embodiments of the present disclosure.

FIG. 5 illustrates a functional diagram of an exemplary communication station that may be suitable for use as a user device, in accordance with one or more example embodiments of the present disclosure.

FIG. 6 illustrates a block diagram of an example machine upon which any of one or more techniques (e.g., methods) may be performed, in accordance with one or more example embodiments of the present disclosure.

FIG. 7 is a block diagram of a radio architecture in accordance with some examples.

FIG. 8 illustrates an example front-end module circuitry for use in the radio architecture of FIG. 7, in accordance with one or more example embodiments of the present disclosure.

FIG. 9 illustrates an example radio IC circuitry for use in the radio architecture of FIG. 7, in accordance with one or more example embodiments of the present disclosure.

FIG. 10 illustrates an example baseband processing circuitry for use in the radio architecture of FIG. 7, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wireless local area networks (WLAN) may be implemented using Wi-Fi protocols defined by the IEEE 802.11 family of technical standards, and may be implemented using Bluetooth protocols as defined by the IEEE 802.15 family of technical standards. WLANs may include multiple devices such as access points (AP) and stations (STA), which may send a variety of frames to one another. For example, an AP may provide wireless networks to which STAs may connect using a device authentication process. Device authentication in Wi-Fi or Bluetooth may involve a STA to establish its identity with an AP. In particular, a STA may send an authentication request with an identifier that identifies the STA (e.g., a medium access control address). The AP may respond with an authentication response that confirms success or failure of the device authentication. Authentication may establish receiver and transmitter addresses of the devices, along with destination and source addresses of the devices, and a service set identifier (SSID) for Wi-Fi or PIN code for Bluetooth. Authentication precedes other processes such as association, which may include establishing matching communication capabilities of associated devices and assigning an identifier (e.g., an association identifier) to a STA.

In wireless connections, for one device to connect to another device, one device may need to enter a SSID and password or PIN to establish the connection. It may not be desirable for one device to send a password over the air in a wireless communication to another device so that the other device may have the password, however. Instead, users may manually enter network passwords into the other device to allow the other device to join a network. In Wi-Fi, one STA authenticated by an AP may provide an STA unauthenticated by the AP with the SSID for the AP to allow the unauthenticated STA to be authenticated by the AP. However, providing the password via Wi-Fi communication may result in an unwanted receiving device receiving the password.

For a STA to receive the SSID and password from another device using Wi-Fi or Bluetooth, the STA may need to establish a link (e.g., P2P) with another device to receive the information. Other ways of a STA receiving the SSID and password may include using cloud-based communications. For example, if an STA enters a room in which a wireless network connection is available, and another STA in the room is already connected to the wireless network, the connected STA may provide the non-connected STA with the SSID and password by sending the SSID and password to the non-connected STA, by using cloud-based communication (e.g., facilitating the sharing of SSID and password with established contacts of a STA), or by allowing the non-connected STA to scan a quick response (QR) code including the SSID and password. Scanning a QR code may be undesirable for users, and sending sensitive information such as SSIDs and passwords may risk interception of the SSIDs and passwords by unintended receiving devices.

Ultrasound may provide a way to communicate sensitive device authentication information without requiring devices to establish a Wi-Fi or Bluetooth connection (e.g., P2P) first, without requiring one device to scan other device, and without significant risk of undesirable reception of SSIDs and passwords (e.g., by devices outside of a room). Ultrasound has a much lower bit rate (e.g., up to 20 kbps) and shorter distance capability than Wi-Fi (and longer distance capability than Bluetooth), and may allow sharing of sensitive data such as SSIDs and passwords for device authentication. However, due to the low bit rate of ultrasound, devices may face a challenge in communicating the number of bits needed to indicate an SSID and password using ultrasound.

Therefore, devices may benefit from ultrasound-assisted device authentication that reduces the number of bits sent over an ultrasound link while taking advantage of the security that short-range ultrasound communications provide.

Example embodiments of the present disclosure relate to systems, methods, and devices for ultrasound-assisted device authentication in Wi-Fi and Bluetooth communications.

In one or more embodiments, devices may send authentication data such as SSIDs and passwords to one another using ultrasound before establishing a connection to one another.

In one or more embodiments, devices may send authentication data such as SSIDs and password to one another using ultrasound so that they can use the authentication data to establish a connection (e.g., Wi-Fi or Bluetooth) with one another, and then use the connection to support peer-to-peer applications, for example, data migration, file/screen sharing, tethering, etc.

In one or more embodiments, devices may establish proximity to one another based on an exchange of short-range ultrasound communications before establishing a connection to one another and using that connection to share sensitive authentication data such as SSIDs and passwords.

In one or more embodiments, a STA authenticated by an AP may assist another STA in becoming authenticated by the AP. For example, an authenticated STA may have a SSID and password for a wireless network hosted by an AP, and may provide the SSID and password to a non-authenticated STA to allow the non-authenticated STA to become authenticated without having to first connect to the authenticated STA and without having to obtain and manually enter the password. The authenticated STA periodically may broadcast an authentication message using ultrasound so that nearby STAs may receive the SSID and password included in the authentication message. The unauthenticated STA may send an authentication request message using ultrasound to the authenticated STA, and the authenticated STA may respond with an authentication response using ultrasound to communicate the SSID and password.

In one or more embodiments, an STA may verify that another STA is within a distance threshold (e.g., proximity) before sharing Wi-Fi or Bluetooth authentication information. For example, a host STA periodically may broadcast an ultrasound proximity authorization request, which may include a random number and a Wi-Fi SSID. The random number may change for each proximity authorization request sent by the authenticated STA. A guest STA, which may be unauthenticated, may identify the ultrasound proximity authorization request, and may respond with an ultrasound proximity authorization response, which may include the same random number of the corresponding proximity authorization request and may include a Bluetooth device address of the guest STA and a randomly generated Bluetooth password (e.g., a PIN or passkey). The host STA may receive the proximity authorization response, determine the round trip time (RTT) from when the ultrasound proximity authorization request was sent to when the proximity authorization response was received. Using the RTT, the host STA may determine the distance between the host STA and the guest STA (e.g., knowing the velocity of the transmissions). When the distance between the STAs is less than a distance threshold (e.g., the STAs are proximal to one another), the STAs may establish a connection (e.g., Bluetooth P2P) with one another using the Bluetooth password. The host or guest STA may determine when the connection is not secure, and may generate a private/public key pair so that the host STA may encrypt a password using the public key when delivering the password to the guest STA. When a connection between the host and guest STAs has been established, the guest STA may send an authentication request message to the host STA over the connection (e.g., Bluetooth P2P link), the request message including a SSID and optionally the public key. The host STA may respond with an authentication response including the SSID and password (e.g., encrypted password when the public key is established). The guest STA may identify the password and use the password to connect to the wireless network (e.g., a Wi-Fi network). The random number may be four bytes. A Bluetooth or Wi-Fi direct address included in the proximity authorization response may be six bytes. The Bluetooth or Wi-Fi direct passkey included in the proximity authorization response may be three bytes.

In one or more embodiments, the number of bits used to communicate a network password and SSID using ultrasound may be reduced. In particular, Wi-Fi SSIDs and passwords may have a significant number of characters to transmit (e.g., 32 characters), and each character may include eight bits using ASCII coding. To account for the relatively low bit rate of ultrasound, enhanced communications using ultrasound to trigger Wi-Fi and Bluetooth connections may reduce the number of bits needed to communicate from one device to another device the SSID and password. For example, when the number of characters allowed for a Wi-Fi SSID and password is 94 characters, ultrasound-assisted triggering of Wi-Fi and Bluetooth connections may use a character index to uniquely identify a subset of allowable characters in a given set of characters used to communicate the SSID and password. As a result, the number of bits per character may be reduced from eight to seven bits.

In one or more embodiments, to uniquely identify a subset of allowable characters in a given set of characters used to communicate the SSID and password, ultrasound-assisted triggering of Wi-Fi and Bluetooth connections may define multiple character sets. In one set, 94 characters may be allowed, including 32 special characters ($, #, &, etc.), all of a-Z and 0-9 (e.g., upper and lowercase), and the number of bits per character may be seven. In another set using all non-special characters (e.g., a-Z and 0-9), 62 characters may be allowed to communicate the SSID and password, resulting in six bits per character. In another set using only lower case characters, the set may be limited to 26 characters, with five bits per character. In another set limited to ten characters, the number of bits per character may be about 3.32 bits when encoded as an integer. An ultrasound-based trigger for Wi-Fi and Bluetooth communications may use a message format with a flag (e.g., two or more bits) to indicate that a network ID field (e.g., also in the ultrasound message format) includes the last N characters of a SSID (e.g., where N is also indicated in the ultrasound message). The flag may indicate that the network ID field includes the last seven bits of a sum of all of the characters representing the SSID. The flag may indicate that the network ID field includes the basic service set identifier (BSSID, six bytes). The flag may indicate that the network ID field includes a Bluetooth device address. The ultrasound message may include another flag to indicate one of the above-mentioned character sets representing the network ID field. The ultrasound message may include an indication of the number of characters used by the Network ID field. The ultrasound message may include another flag to indicate one of the above-mentioned character sets for a password field included in the ultrasound message. By providing such indications, the ultrasound message may not need to include the entire number of bits of a SSID and password, and instead may include indications of the SSID and password using a reduced number of bits.

In one or more embodiments, ultrasound-based triggering may facilitate one or more processes, such as a data migration process from an old computer to a new computer. For example, after a new computer has been started, the new computer may display an indication that a computer refresh tool is available for downloading and installation. The computer may download, install, and launch the refresh tool on the old computer, and when the new computer receives a request to continue the data migration process, the new computer may establish a P2P connection with the old computer using the above-described ultrasound-assisted pairing method (e.g., in which ultrasound messaging is used to establish the P2P connection). The old computer may provide its name, SSID, and password to the new computer using the P2P connection (e.g., Bluetooth or Wi-Fi). The new computer may establish an online connection and configure itself to operate as a direct Wi-Fi access point. The new computer may provide a direct Wi-Fi SSID and password to the old computer via the P2P link (e.g., using a Bluetooth P2P link), and may establish a direct Wi-Fi connection between the two devices. Once the direct connection has been established, the data from the old computer may be migrated to the new computer using the direct connection.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

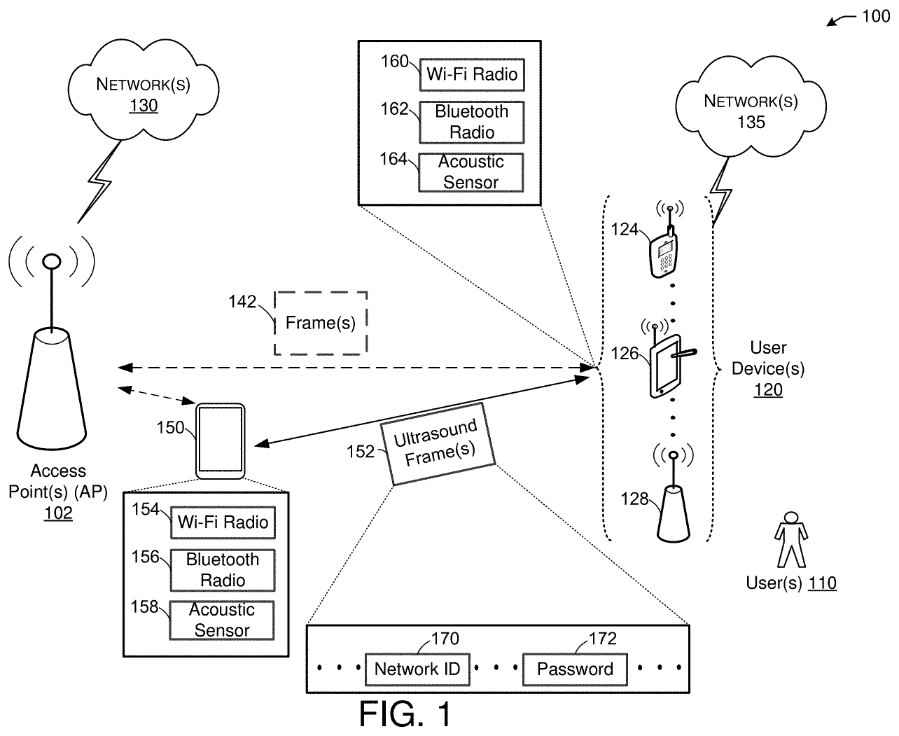

FIG. 1 is a network diagram illustrating an exemplary network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

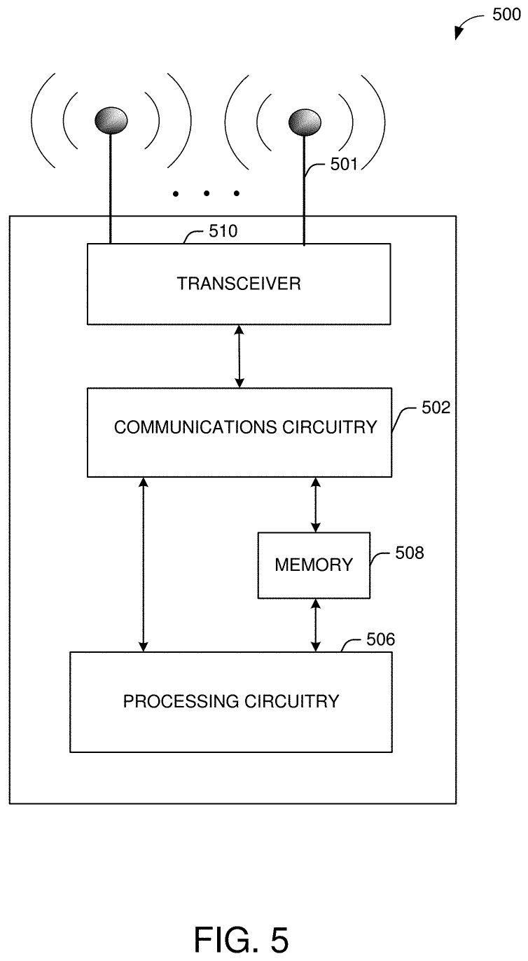

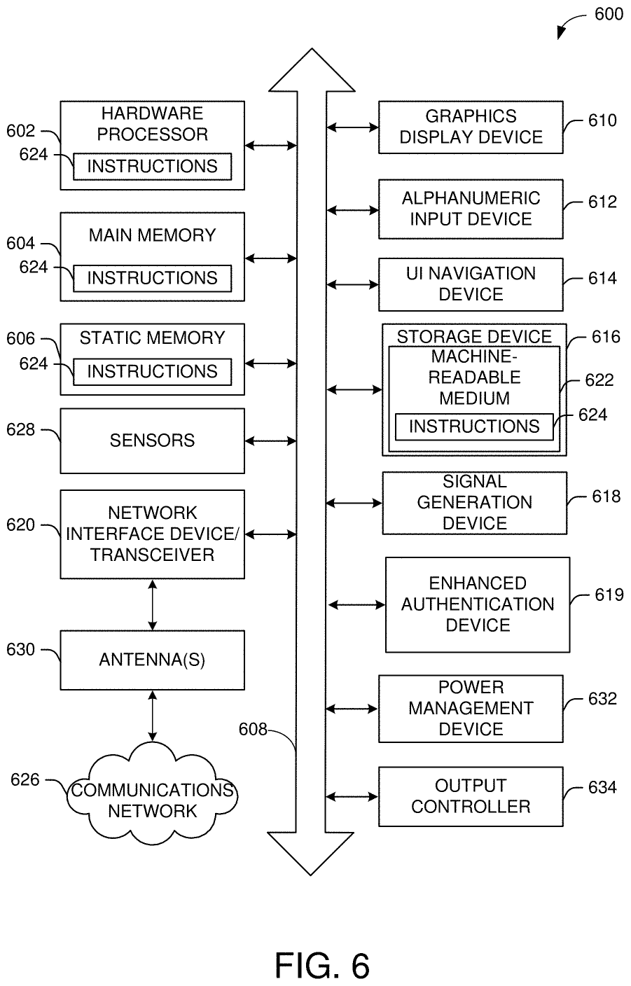

In some embodiments, the user devices 120 and the AP 102 may include one or more computer systems similar to that of the functional diagram of FIG. 5 and/or the example machine/system of FIG. 6.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile (e.g., a static) device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, AP 102 may communicate with one or more user devices 120. The AP 102 and the one or more user devices 120 may exchange one or more frames 142. The one or more frames 142 may include Wi-Fi frames or Bluetooth frames. The one or more user devices 120 may exchange one or more ultrasound frames 152 with a user device 150. For example, the one or more user devices 120 may be connected to a Wi-Fi network hosted by the AP 102, and may send the one or more ultrasound frames 152 to the user device 150 to allow the user device 150 to be authenticated by the AP 102 and to join the Wi-Fi network. Alternatively, a user device (e.g., the user device 126) of the one or more user devices 120 may establish a P2P connection (e.g., Wi-Fi or Bluetooth) with the user device 150 by exchanging the one or more ultrasound frames 152.

In one or more embodiments, still referring to FIG. 1, the user device 150 may include a Wi-Fi radio 154, a Bluetooth radio 156, and an acoustic sensor 158. Any of the one or more user devices 120 may include a Wi-Fi radio 160, a Bluetooth radio 162, and an acoustic sensor 164. The Wi-Fi radio 154 and the Wi-Fi radio 160 may operate according to the IEEE 802.11 technical standards. The Bluetooth radio 156 and the Bluetooth radio 162 may operate according to the IEEE 802.15 technical standards. The acoustic sensor 158 and the acoustic sensor 164 may function as transmitters and receivers for the transmission and reception of ultrasound signals (e.g., the one or more ultrasound frames 152), and the conversion of ultrasound signals to electrical signals (and vice versa). The Wi-Fi radio 154, the Bluetooth radio 156, and the acoustic sensor 158 may use the same or different hardware. The Wi-Fi radio 160, the Bluetooth radio 162, and the acoustic sensor 164 may use the same or different hardware.

In one or more embodiments, still referring to FIG. 1, the one or more ultrasound frames 152 may include at least a portion of a network ID 170 (e.g., a SSID) and a password 172 (e.g., a device or network password). The network ID 170 and password 172 may be associated with a wireless network (e.g., Wi-Fi or Bluetooth), and the one or more ultrasound frames 152 may be sent to indicate the network ID 170 and password 172 to allow the user device 150 to connect to the wireless network or to establish a direct P2P connection with the one or more user devices 120 as explained further below.

It is understood that the above descriptions are for purposes of illustration and are not meant to be limiting.

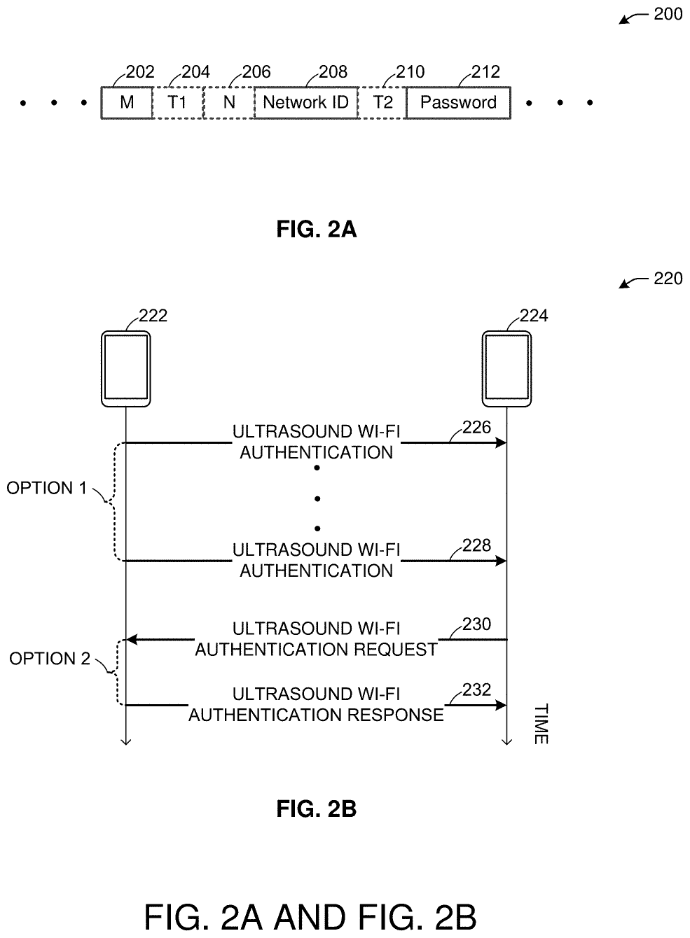

FIG. 2A depicts an illustrative portion 200 of an ultrasound frame format, in accordance with one or more example embodiments of the present disclosure.

Referring to FIG. 2, the portion 200 of an ultrasound frame format may include one or more fields, such as an M field 202, T1 field 204, an N field 206, a network ID field 208, a T2 field 210, and a password field 212. The T1 field 204, the N field 206, and the T2 field 210 may be optional as described herein. The portion 200 of an ultrasound frame format may be used to communicate at least a portion of a SSID (e.g., in the network ID field 208) and a password without requiring eight bits per character, thereby taking advantage of ultrasound's relatively low bit rate. The portion 200 of an ultrasound frame format may be included in the one or more ultrasound frames 152 of FIG. 1.

In one or more embodiments, the M field 202 may be a flag (e.g., using two or more bits) which indicates one of multiple options. In a first option (e.g., when the M field 202 has a zero value), the M field 202 may indicate that the Network ID field 208 includes the last N characters (e.g., indicated by the N field 206) of a SSID (e.g., a Wi-Fi SSID). In a second option (e.g., when the M field 202 has a value of one), the M field 202 may indicate that the Network ID field 208 includes the last seven bits (e.g., Least Significant Bits) of a sum of all characters of a SSID (e.g., a Wi-Fi SSID). In a third option (e.g., when the M field 202 has a value of two), the M field 202 may indicate that the Network ID field 208 includes a BSSID (e.g., a Wi-Fi BSSID having six bytes). In a fourth option (e.g., when the M field 202 has a value of 3), the M field 202 may indicate that the Network ID field 208 includes a Bluetooth device address, and the password field 212 may be limited to a 6-digit device password. In this manner, a device which receives an ultrasound frame may be able to determine a Wi-Fi SSID or Bluetooth device address without having the ultrasound frame having to include bits for every character of a SSID. When a receiving device identifies a portion of a SSID, the receiving device may determine the corresponding SSID. For example, if the SSID is ABCD1234, and the Network ID field 208 includes CD1234 (e.g., option 1 with the N field 206 including an indication of six characters), the receiving device may identify the SSID ABCD1234 by matching the portion of the SSID included in the Network ID field 208 to an available SSID (e.g., based on a probe request/response exchange or another exchange which notifies the receiving device of a nearby SSID).

In one or more embodiments, the T1 field 204 may be a flag which may indicate a character set for the network ID field 208. In one set (set 1), 94 characters may be allowed for the Network ID field 208 and the password field 212, including 32 special characters ($, #, &, etc.), all of a-Z and 0-9 (e.g., upper and lowercase), and the number of bits per character may be seven. In another set (e.g. set 2) using all non-special characters (e.g., a-Z and 0-9), 62 characters may be allowed to communicate the SSID and password, resulting in six bits per character. In another set (e.g., set 3) using only lower case characters, the set may be limited to 26 characters, with five bits per character. In another set (e.g., set 4) limited to ten characters, the number of bits per character may be about 3.32 bits when encoded as an integer. When the T1 field 204 has a zero value, the character set may be set 1. When the T1 field 204 has a value of one, the character set may be set 2. When the T1 field 204 has a value of two, the character set may be set 3. When the T1 field 204 has a value of two, the character set may be set 3. When the T1 field 204 has a value of three, the character set may be set 4. The T2 field 210 may be a flag (e.g., two or more bits) which may indicate which character set applies for the password field 212. The N field 206 may be a flag (e.g., four or more bits) indicating the number of characters in the network ID field 208.

In one or more embodiments, when the M field 202 is set to one (e.g., option 2), two (option 3), or three (option 4), the T1 field 204 and the N field 206 may not be needed and may be excluded. When the M field 202 is set to three (option 4), the T2 field may not be needed and may be excluded because the T2 field. When the M field 202 has a zero value, all of the fields in the portion 200 of an ultrasound frame format shown in FIG. 2A may be included in an ultrasound Wi-Fi authentication message. When the M field 202 has a value of one or two, the portion 200 of an ultrasound frame format may include the M field 202, the network ID field 208, and the password field 212 in an ultrasound Wi-Fi authentication message, and may exclude the T1 field 204, the N field 206, and the T2 field 210.

In one or more embodiments, a device (e.g., the user device 126 of the one or more user devices 120 of FIG. 1) periodically may broadcast a Wi-Fi authentication message (e.g., the one or more ultrasound frames 152 of FIG. 1) using an ultrasound radio (e.g., the acoustic sensor 164 of FIG. 1). Nearby devices, such as the user device 150, may receive the Wi-Fi authentication message (e.g., using the acoustic sensor 158 of FIG. 1), may translate the ultrasound-based message to one or more electric signals, may identify the password included in the password field 212, and may use the password to connect to a device (e.g., the AP 102 of FIG. 1).

In one or more embodiments, a device (e.g., the user device 126 of the one or more user devices 120 of FIG. 1) may send a Wi-Fi authentication message (e.g., the one or more ultrasound frames 152 of FIG. 1) using an ultrasound radio (e.g., the acoustic sensor 164 of FIG. 1) in response to a request received from another device (e.g., the user device 150 of FIG. 1). In such a response transmission, when the M field 202 is one or two, the T1 field 204 may be excluded from the ultrasound-based Wi-Fi authentication message.

FIG. 2B depicts an illustrative sequence 250 of ultrasound-assisted Wi-Fi authentication, in accordance with one or more example embodiments of the present disclosure.

Referring to FIG. 2B, two options are shown: Option 1, and option 2. In option 1, a user device 222 periodically may broadcast Wi-Fi authentication messages (e.g., ultrasound Wi-Fi authentication 226, ultrasound Wi-Fi authentication 228) using an ultrasound radio (e.g., the acoustic sensor 164 of FIG. 1). The Wi-Fi authentication message may include the portion 200 of an ultrasound frame format shown in FIG. 2A. A nearby user device 224 may receive the Wi-Fi authentication messages (e.g., using the acoustic sensor 158 of FIG. 1), may translate the ultrasound-based message to one or more electric signals, may identify a password (e.g., included in the password field 212 of FIG. 2A), and may use the password to connect to a device (e.g., the AP 102 of FIG. 1).

Still referring to FIG. 2B, option 2 (e.g. an on-demand option) may include the user device 224 sending an ultrasound Wi-Fi authentication request 230. The user device 222 may receive the ultrasound Wi-Fi authentication request 230, and may respond by sending an ultrasound Wi-Fi authentication response 232 (e.g., including the portion 200 of an ultrasound frame format shown in FIG. 2A). When the M field 202 of the portion 200 of an ultrasound frame format shown in FIG. 2A included in the Wi-Fi authentication response 232 has a value of one, the network ID field 208 of the portion 200 of an ultrasound frame format shown in FIG. 2A included in the Wi-Fi authentication response 232 may be shorter in length (e.g., number of bits) than when the M field 202 is another value.

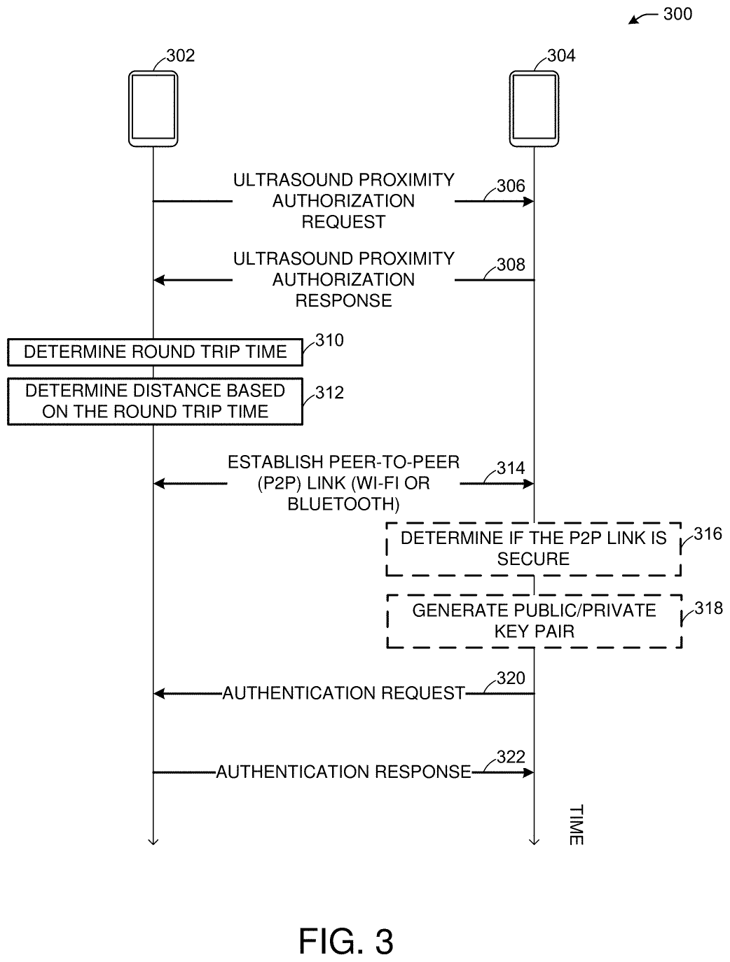

FIG. 3 depicts an illustrative sequence 300 of ultrasound-assisted device authentication, in accordance with one or more example embodiments of the present disclosure.

Referring to FIG. 3, a user device 302 and a user device 304 may share Wi-Fi and/or Bluetooth authentication information when the distance between the user device 302 and the user device 304 is within a distance threshold. At step 306, the user device 302 may send an ultrasound proximity authorization request (e.g., using an ultrasound radio). The ultrasound proximity authorization request may include a SSID and/or a random number which may change (e.g., increment) with every exchanged message. The user device 304 may receive the ultrasound proximity authorization request. At step 308, the user device 304 may send an ultrasound proximity authorization response (e.g., using an ultrasound radio). The user device 302 may receive the ultrasound proximity authorization response. The ultrasound proximity authorization response may include the same random number as was included in step 306, along with a Bluetooth device address and a Bluetooth password (e.g., a PIN or PassKey), which may be randomly generated. At step 310, the user device 302 may determine a round trip time from the time at which the ultrasound proximity authorization request was sent to the time at which the ultrasound proximity authorization response was received. Based on the round trip time and a known propagation speed of ultrasound signals, at step 312, the user device 302 may determine a distance between the user device 302 and the user device 304. Because of the relatively slow propagation speed of ultrasound (e.g., compared to Wi-Fi), the round trip time calculation, and therefore the determination of distance between devices, may be relatively accurate when compared to communication modes with faster propagation.

Still referring to FIG. 3, at step 314, the user device 302 and the user device 304 may establish a P2P connection (e.g., Bluetooth using the Bluetooth pairing information) with one another when the distance between the user device 302 and the user device 304 is less than a distance threshold. The distance threshold may be set based on a distance that is safe to transmit SSIDs and passwords between the user device 302 and the user device 304 using the P2P link between the devices. At step 316, the user device 304 optionally may determine if the P2P link is secure. When the P2P link is not secure, the user device 304 optionally may generate a public/private key pair at step 318 for encryption. At step 320, the user device 304 may send (e.g., using the P2P link) an authentication request to the user device 302, including a SSID and the public key (if one is generated for encryption of the authentication request). The user device 302 may receive the authentication request, and may send, at step 322, an authentication response to the user device 304 (e.g., using the P2P link), including a Wi-Fi SSID and password. When the public key is provided at step 320, the user device 302 may use the public key to encrypt the Wi-Fi password at step 322. The user device 304 may receive the Wi-Fi password, and may provide the password to an AP (e.g., the AP 102 of FIG. 1) to connect to the network provided by the AP.

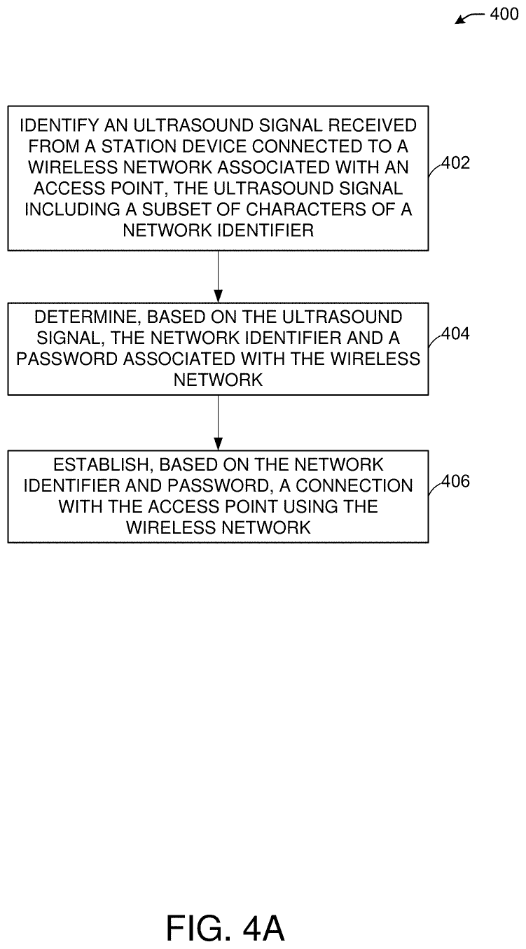

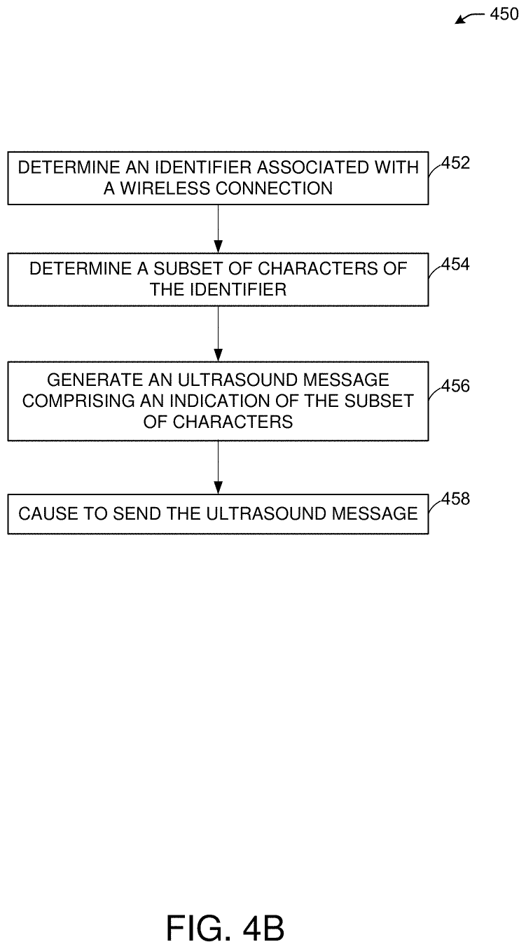

FIG. 4A illustrates a flow diagram of illustrative process 400 for ultrasound-assisted Wi-Fi and Bluetooth device authentication, in accordance with one or more example embodiments of the present disclosure.

At block 402, processing circuitry of a device (e.g., the user device 222 of FIG. 2B) may identify an ultrasound signal (e.g., the Wi-Fi authentication 226 or the Wi-Fi authentication response 232 of FIG. 2B) received from another device (e.g., the user device 224 of FIG. 2B) which may be connected to a wireless network provided by an AP (e.g., the AP 102 of FIG. 1). The ultrasound signal may include a subset of available characters and/or bits used to define a network identifier (e.g., SSID) and a network password or a Bluetooth device identifier and password. The ultrasound signal may be sent by the other device as part of a periodic transmission, or may be sent in response to an ultrasound authentication request (e.g., the ultrasound Wi-Fi authentication request 230 of FIG. 2B) sent by the device.

At block 404, the processing circuitry of the device may determine the network identifier and password based on the information in the ultrasound signal. For example, a flag in the ultrasound signal may indicate the last N characters of the network identifier, the last seven bits of the sum of the characters of a network identifier, a Wi-Fi BSSID (e.g., six bytes), or a Bluetooth device address. Another flag in the ultrasound signal may indicate a character set used to name the network identifier. While 94 characters may be available to create network identifier and password, another flag in the ultrasound signal may indicate a character set using less than eight bits per character (e.g., 94 characters, 62 characters, 26 characters, or 10 characters). The subset of characters and/or bits may allow the device to determine the network identifier and password without having to receive all of the characters used in the network identifier.

At block 406, the processing circuitry of the device may cause the device to establish a connection with the AP using the wireless network based on the network identifier and password. For example, the other device may be connected to a wireless network provided by the AP, and the device may not be connected to the AP. The network identifier and password may correspond to the wireless network provided by the AP. The device may be authenticated by the AP by providing one or more transmissions to the AP with the network identifier and/or password. Alternatively, the device may establish a Bluetooth connection with the other device based on the Bluetooth device identifier and password by exchanging one or more communications with the other device including the Bluetooth device identifier and/or password.

FIG. 4B illustrates a flow diagram of illustrative process 450 for ultrasound-assisted Wi-Fi and Bluetooth device authentication, in accordance with one or more example embodiments of the present disclosure.

At block 452, processing circuitry of a device (e.g., the user device 224 of FIG. 2B) may determine an identifier (e.g., SSID, Bluetooth device identifier) associated with a wireless connection (e.g., Wi-Fi or Bluetooth). The device may be connect to an AP (e.g., the AP 102 of FIG. 1) and may provide the corresponding SSID and password to another device. Alternatively, the device may provide its Bluetooth address and password to the other device.

At block 454, the processing circuitry of the device may determine a subset of available characters and/or bits used to define a network identifier (e.g., SSID) and a network password or a Bluetooth device identifier and password. For example, a flag in the ultrasound signal may indicate the last N characters of the network identifier, the last seven bits of the sum of the characters of a network identifier, a Wi-Fi BSSID (e.g., six bytes), or a Bluetooth device address. The device may include another flag in the ultrasound signal to indicate the character set used to define the network identifier. While 94 characters may be available to create network identifier and password, another flag in the ultrasound signal may indicate a character set using less than eight bits per character (e.g., 94 characters, 62 characters, 26 characters, or 10 characters). The subset of characters and/or bits may allow the other device to determine the network identifier and password without having to receive all of the characters used in the network identifier.

At block 456, the processing circuitry of the device may generate an ultrasound message (e.g., the Wi-Fi authentication 226 or the Wi-Fi authentication response 232 of FIG. 2B). The ultrasound message may include a flag indicating the subset of characters and/or bits and a flag indicating the character set. The flags may allow the other device to determine the network identifier and password without having to receive every character of the network identifier. Because not every character need be included in the ultrasound signal, a reduced number of bits may be required to send the ultrasound signal.

At block 458, the processing circuitry of the device may cause the device to send the ultrasound message. The device may establish a Bluetooth connection with the other device when the identifier provided by the device in the ultrasound signal is a Bluetooth device address and password. When the identifier provided by the device in the ultrasound signal is a Wi-Fi SSID, the Wi-Fi SSID and password may be used by the other device to establish a connection and authentication with the AP which provides the Wi-Fi network.

It is understood that the above descriptions are for purposes of illustration and are not meant to be limiting.

FIG. 5 shows a functional diagram of an exemplary communication station 500 in accordance with some embodiments. In one embodiment, FIG. 5 illustrates a functional block diagram of a communication station that may be suitable for use as an AP 102 (FIG. 1) or user device 120 (FIG. 1) in accordance with some embodiments. The communication station 500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or media access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in FIGS. 1, 2A, 2B, 3, 4A, and 4B.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random- access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device memory.

FIG. 6 illustrates a block diagram of an example of a machine 600 or system upon which any one or more of the techniques (e.g., methodologies) discussed herein may be performed. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an enhanced authentication device 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 602 for generation and processing of the baseband signals and for controlling operations of the main memory 604, the storage device 616, and/or the enhanced authentication device 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The enhanced authentication device 619 may carry out or perform any of the operations and processes (e.g., process 400 of FIG. 4A, process 450 of FIG. 4B) described and shown above.

In one or more embodiments, devices may send authentication data such as SSIDs and password to one another using ultrasound so that they can use the authentication data to establish a connection (e.g., Wi-Fi or Bluetooth) with one another, and then use the connection to support peer-to-peer applications, for example, data migration, file/screen sharing, tethering, etc.

In one or more embodiments, devices may establish proximity to one another based on an exchange of short-range ultrasound communications using the enhanced authentication device 619 before establishing a connection to one another and using that connection to share sensitive authentication data such as SSIDs and passwords.

In one or more embodiments, a STA authenticated by an AP may assist another STA in becoming authenticated by the AP. For example, an authenticated STA may have a SSID and password for a wireless network hosted by an AP, and may provide the SSID and password to a non-authenticated STA to allow the non-authenticated STA to become authenticated without having to first connect to the authenticated STA and without having to obtain and manually enter the password. The enhanced authentication device 619 may cause the authenticated STA to broadcast an authentication message using ultrasound so that nearby STAs may receive the SSID and password included in the authentication message. The unauthenticated STA may send an authentication request message using ultrasound to the authenticated STA, and the authenticated STA may respond with an authentication response using ultrasound to communicate the SSID and password.

In one or more embodiments, an STA may verify that another STA is within a distance threshold (e.g., proximity) before sharing Wi-Fi or Bluetooth authentication information. For example, the enhanced authentication device 619 may cause a host STA to broadcast an ultrasound proximity authorization request, which may include a random number and a Wi-Fi SSID. The random number may change for each proximity authorization request sent by the authenticated STA. A guest STA, which may be unauthenticated, may identify the ultrasound proximity authorization request, and may respond with an ultrasound proximity authorization response, which may include the same random number of the corresponding proximity authorization request and may include a Bluetooth device address of the guest STA and a randomly generated Bluetooth password (e.g., a PIN or passkey). The host STA may receive the proximity authorization response, determine the round trip time (RTT) from when the ultrasound proximity authorization request was sent to when the proximity authorization response was received. Using the RTT, the host STA may determine the distance between the host STA and the guest STA (e.g., knowing the velocity of the transmissions). When the distance between the STAs is less than a distance threshold (e.g., the STAs are proximal to one another), the STAs may establish a connection (e.g., Bluetooth P2P) with one another using the Bluetooth password. The host or guest STA may determine when the connection is not secure, and may generate a private/public key pair so that the host STA may encrypt a password using the public key when delivering the password to the guest STA. When a connection between the host and guest STAs has been established, the guest STA may send an authentication request message to the host STA over the connection (e.g., Bluetooth P2P link), the request message including a SSID and optionally the public key. The host STA may respond with an authentication response including the SSID and password (e.g., encrypted password when the public key is established). The guest STA may identify the password and use the password to connect to the wireless network (e.g., a Wi-Fi network). The random number may be four bytes. A Bluetooth or Wi-Fi direct address included in the proximity authorization response may be six bytes. The Bluetooth or Wi-Fi direct passkey included in the proximity authorization response may be three bytes.

In one or more embodiments, the number of bits used to communicate a network password and SSID using ultrasound may be reduced. In particular, Wi-Fi SSIDs and passwords may have a significant number of characters to transmit (e.g., 32 characters), and each character may include eight bits using ASCII coding. To account for the relatively low bit rate of ultrasound, the enhanced authentication device 619 may reduce the number of bits needed to communicate from one device to another device the SSID and password. For example, when the number of characters allowed for a Wi-Fi SSID and password is 94 characters, ultrasound-assisted triggering of Wi-Fi and Bluetooth connections may use a character index to uniquely identify a subset of allowable characters in a given set of characters used to communicate the SSID and password. As a result, the number of bits per character may be reduced from eight to seven bits.

In one or more embodiments, to uniquely identify a subset of allowable characters in a given set of characters used to communicate the SSID and password, the enhanced authentication device 619 may define multiple character sets. In one set, 94 characters may be allowed, including 32 special characters ($, #, &, etc.), all of a-Z and 0-9 (e.g., upper and lowercase), and the number of bits per character may be seven. In another set using all non-special characters (e.g., a-Z and 0-9), 62 characters may be allowed to communicate the SSID and password, resulting in six bits per character. In another set using only lower case characters, the set may be limited to 26 characters, with five bits per character. In another set limited to ten characters, the number of bits per character may be about 3.32 bits when encoded as an integer. An ultrasound-based trigger for Wi-Fi and Bluetooth communications may use a message format with a flag (e.g., two or more bits) to indicate that a network ID field (e.g., also in the ultrasound message format) includes the last N characters of a SSID (e.g., where N is also indicated in the ultrasound message). The flag may indicate that the network ID field includes the last seven bits of a sum of all of the characters representing the SSID. The flag may indicate that the network ID field includes the basic service set identifier (BSSID, six bytes). The flag may indicate that the network ID field includes a Bluetooth device address. The ultrasound message may include another flag to indicate one of the above-mentioned character sets representing the network ID field. The ultrasound message may include an indication of the number of characters used by the Network ID field. The ultrasound message may include another flag to indicate one of the above-mentioned character sets for a password field included in the ultrasound message. By providing such indications, the ultrasound message may not need to include the entire number of bits of a SSID and password, and instead may include indications of the SSID and password using a reduced number of bits.

In one or more embodiments, the enhanced authentication device 619 may facilitate one or more processes, such as a data migration process from an old computer to a new computer. For example, after a new computer has been started, the new computer may display an indication that a computer refresh tool is available for downloading and installation. The computer may download, install, and launch the refresh tool on the old computer, and when the new computer receives a request to continue the data migration process, the new computer may establish a P2P connection with the old computer using the above-described ultrasound-assisted pairing method (e.g., in which ultrasound messaging is used to establish the P2P connection). The old computer may provide its name, SSID, and password to the new computer using the P2P connection (e.g., Bluetooth or Wi-Fi). The new computer may establish an online connection and configure itself to operate as a direct Wi-Fi access point. The new computer may provide a direct Wi-Fi SSID and password to the old computer via the P2P link (e.g., using a Bluetooth P2P link), and may establish a direct Wi-Fi connection between the two devices. Once the direct connection has been established, the data from the old computer may be migrated to the new computer using the direct connection.

It is understood that the above are only a subset of what the enhanced authentication device 619 may be configured to perform and that other functions included throughout this disclosure may also be performed by the enhanced authentication device 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may be a device comprising memory and processing circuitry configured to: identify an ultrasound message received from a first device, wherein the ultrasound message includes a subset of characters or a subset of bits associated with a wireless connection; determine, based on the subset of characters or the subset of bits, an identifier associated with the wireless connection; determine, based on the ultrasound message, a password associated with the wireless connection; and establish the wireless connection using the identifier and the password.

Example 2 may include the device of example 1 and/or some other example herein, wherein the processing circuitry is further configured to send an ultrasound request to the first device, and wherein the ultrasound message is received in response to the ultrasound request.

Example 3 may include the device of example 1 and/or some other example herein, wherein the wireless connection is a Wi-Fi connection with an access point, and wherein to determine the identifier comprises the processing circuitry being further configured to: determine a flag indicating the subset of characters; determine, based on the flag, that the subset of characters comprises a subset of characters associated with a Wi-Fi service set identifier (SSID), a subset of characters associated with a Wi-Fi password, a subset of bits associated with a sum of all characters of the Wi-Fi SSID, or a Wi-Fi basic service set identifier (BSSID); and determine, based on the subset of characters or the subset of bits, the identifier and the password, wherein to establish the wireless connection comprises the processing circuitry being further configured to establish a connection with the access point.

Example 4 may include the device of example 3 and/or some other example herein, wherein the Wi-Fi connection is a Wi-Fi direct connection.

Example 5 may include the device of example 1 and/or some other example herein, wherein the wireless connection is a Bluetooth connection with the first device, and wherein to determine the identifier comprises the processing circuitry being further configured to: determine a flag indicating the subset of characters; determine, based on the flag, that the subset of characters comprises a Bluetooth address associated with the first device; and determine, based on the subset of characters, the identifier and the password, wherein to establish the wireless connection comprises the processing circuitry being further configured to establish a connection with the device.

Example 6 may include the device of example 1 and/or some other example herein, wherein the processing circuitry is further configured to determine that the ultrasound message comprises a flag indicating that 94 characters are allowed for the identifier and the password, wherein the 94 characters use seven bits per character, wherein the 94 characters consist of lower case letters, upper case letters, symbols, and numbers, and wherein to determine the identifier is further based on the flag.

Example 7 may include the device of example 1 and/or some other example herein, wherein the processing circuitry is further configured to determine that the ultrasound message comprises a flag indicating that 62 characters are allowed for the identifier and the password, wherein the 62 characters use six bits per character, wherein the 62 characters consist of lower case letters, upper case letters, and numbers, and wherein to determine the identifier is further based on the flag.

Example 8 may include the device of example 1 and/or some other example herein, wherein the processing circuitry is further configured to determine that the ultrasound message comprises a flag indicating that 26 characters are allowed for the identifier and the password, wherein the 26 characters use five bits per character, wherein the 26 characters consist of lower case characters.

Example 9 may include the device of example 1 and/or some other example herein, wherein the processing circuitry is further configured to determine that the ultrasound message comprises a flag indicating that 10 characters are allowed for the identifier and the password, and wherein the 10 characters consist of numbers, and wherein to determine the identifier is further based on the flag.

Example 10 may include the device of example 1 and/or some other example herein, further comprising one or more transceivers configured to transmit and receive wireless signals, wherein the wireless signals comprise the ultrasound message and one or more messages associated with establishing the wireless connection.

Example 11 may include the device of example 10 and/or some other example herein, further comprising one or more antennas coupled to the one or more transceivers.

Example 12 may include a non-transitory computer-readable medium storing computer-executable instructions which when executed by one or more processors result in performing operations comprising: determining, by a device, an identifier associated with a wireless connection, wherein the identifier comprises characters; determining a subset of the characters; generating an ultrasound message comprising a password associated with the wireless connection and an indication of the subset of the characters; and causing to send the ultrasound message.

Example 13 may include the non-transitory computer-readable medium of example 12 and/or some other example herein, wherein the device is a first device, the operations further comprising identifying an ultrasound request received from a second device, wherein generating the ultrasound message is based on receiving the ultrasound request.

Example 14 may include the non-transitory computer-readable medium of example 11 and/or some other example herein, wherein the device is a first device, wherein the subset of the characters comprises a Bluetooth address associated with the first device, wherein generating the ultrasound message comprises generating a flag indicative of the Bluetooth address, and wherein the ultrasound message comprises the flag, and wherein the wireless connection is a Bluetooth connection, the operations further comprising establishing the Bluetooth connection with a second device based on the password.

Example 15 may include the non-transitory computer-readable medium of example 12 and/or some other example herein, wherein the wireless connection is a Wi-Fi connection with an access point, wherein the subset of the characters comprises a subset of characters associated with a Wi-Fi service set identifier (SSID), a subset of bits associated with a sum of all characters of the Wi-Fi SSID, or a Wi-Fi basic service set identifier (BSSID), wherein generating the ultrasound message comprises generating a flag indicating the subset of the characters, and wherein the ultrasound messages comprises the flag.

Example 16 may include the non-transitory computer-readable medium of example 12 and/or some other example herein, wherein generating the ultrasound message comprises generating a flag indicating a number of characters allowed for the identifier and the password, and wherein the ultrasound message comprises the flag.

Example 17 may include the non-transitory computer-readable medium of example 16 and/or some other example herein, wherein the number of characters is 94, 62, 26, or 10, and wherein the number of characters is associated with less than eight bits per character.

Example 18 may include a method comprising: causing to send, by processing circuitry of a first device, an ultrasound request; identifying, by the processing circuitry of the first device, an ultrasound response received from a second device; determining, by the processing circuitry and based on the ultrasound request and the ultrasound response, a distance between the first device and the second device; establishing a peer-to-peer connection with the second device based on the distance; identifying an authentication request received from the second device using the peer-to-peer connection, wherein the authentication request comprises a Wi-Fi service set identifier (SSID); and causing to send an authentication response to the second device using the peer-to-peer connection, wherein the authentication response comprises the Wi-Fi SSID and a password.

Example 19 may include the method of example 18 and/or some other example herein, wherein the ultrasound response comprises a Bluetooth address associated with the first device and a Bluetooth password associated with the first device, and wherein establishing the peer-to-peer connection comprises establishing a Bluetooth connection based on the Bluetooth address and the Bluetooth password.

Example, 20 may include the method of example 15 and/or some other example herein, wherein determining the distance comprises: determining a round trip time associated with the ultrasound request and the ultrasound response; and determining, based on the round trip time, the distance, wherein establishing the peer-to-peer connection based on the distance comprises: determining that the distance is less than a distance threshold; and establishing a Bluetooth connection based on the distance being less than the distance threshold.

Example 21 may include an apparatus comprising means for: identifying an ultrasound message received from a first device, wherein the ultrasound message includes a subset of characters or a subset of bits associated with a wireless connection; determining, based on the subset of characters or the subset of bits, an identifier associated with the wireless connection; determining, based on the ultrasound message, a password associated with the wireless connection; and establishing the wireless connection using the identifier and the password.

Example 22 may include an apparatus comprising means for: causing to send an ultrasound request; identifying an ultrasound response received from a second device; determining, based on the ultrasound request and the ultrasound response, a distance between the first device and the second device; establishing a peer-to-peer connection with the second device based on the distance; identifying an authentication request received from the second device using the peer-to-peer connection, wherein the authentication request comprises a Wi-Fi service set identifier (SSID); and causing to send an authentication response to the second device using the peer-to-peer connection, wherein the authentication response comprises the Wi-Fi SSID and a password.

Example 23 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 23 may include an apparatus comprising logic, modules, and/or circuitry to perform one or more elements of a method described in or related to any of examples 1-22, or any other method or process described herein.

Example 24 may include a method, technique, or process as described in or related to any of examples 1-22, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-22, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

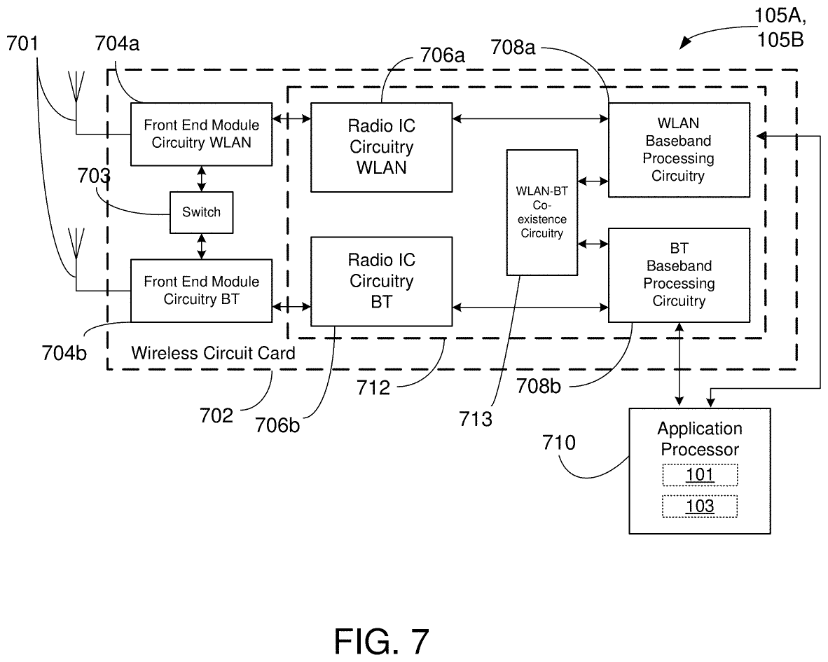

FIG. 7 is a block diagram of a radio architecture 105A, 105B in accordance with some embodiments that may be implemented in any one of the example AP 102 and/or the example user device(s)120 of FIG. 1. Radio architecture 105A, 105B may include radio front-end module (FEM) circuitry 704a-b, radio IC circuitry 706a-b and baseband processing circuitry 708a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 704a-b may include a WLAN or Wi-Fi FEM circuitry 704a and a Bluetooth (BT) FEM circuitry 704b. The WLAN FEM circuitry 704a may include a receive signal path comprising circuitry configured to operate on WLAN RF signals received from one or more antennas 701, to amplify the received signals and to provide the amplified versions of the received signals to the WLAN radio IC circuitry 706a for further processing. The BT FEM circuitry 704b may include a receive signal path which may include circuitry configured to operate on BT RF signals received from one or more antennas 701, to amplify the received signals and to provide the amplified versions of the received signals to the BT radio IC circuitry 706b for further processing. FEM circuitry 704a may also include a transmit signal path which may include circuitry configured to amplify WLAN signals provided by the radio IC circuitry 706a for wireless transmission by one or more of the antennas 701. In addition, FEM circuitry 704b may also include a transmit signal path which may include circuitry configured to amplify BT signals provided by the radio IC circuitry 706b for wireless transmission by the one or more antennas. In the embodiment of FIG. 7, although FEM 704a and FEM 704b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 706a-b as shown may include WLAN radio IC circuitry 706a and BT radio IC circuitry 706b. The WLAN radio IC circuitry 706a may include a receive signal path which may include circuitry to down-convert WLAN RF signals received from the FEM circuitry 704a and provide baseband signals to WLAN baseband processing circuitry 708a. BT radio IC circuitry 706b may in turn include a receive signal path which may include circuitry to down-convert BT RF signals received from the FEM circuitry 704b and provide baseband signals to BT baseband processing circuitry 708b. WLAN radio IC circuitry 706a may also include a transmit signal path which may include circuitry to up-convert WLAN baseband signals provided by the WLAN baseband processing circuitry 708a and provide WLAN RF output signals to the FEM circuitry 704a for subsequent wireless transmission by the one or more antennas 701. BT radio IC circuitry 706b may also include a transmit signal path which may include circuitry to up-convert BT baseband signals provided by the BT baseband processing circuitry 708b and provide BT RF output signals to the FEM circuitry 704b for subsequent wireless transmission by the one or more antennas 701. In the embodiment of FIG. 7, although radio IC circuitries 706a and 706b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 708a-b may include a WLAN baseband processing circuitry 708a and a BT baseband processing circuitry 708b. The WLAN baseband processing circuitry 708a may include a memory, such as, for example, a set of RAM arrays in a Fast Fourier Transform or Inverse Fast Fourier Transform block (not shown) of the WLAN baseband processing circuitry 708a. Each of the WLAN baseband circuitry 708a and the BT baseband circuitry 708b may further include one or more processors and control logic to process the signals received from the corresponding WLAN or BT receive signal path of the radio IC circuitry 706a-b, and to also generate corresponding WLAN or BT baseband signals for the transmit signal path of the radio IC circuitry 706a-b. Each of the baseband processing circuitries 708a and 708b may further include physical layer (PHY) and medium access control layer (MAC) circuitry, and may further interface with a device for generation and processing of the baseband signals and for controlling operations of the radio IC circuitry 706a-b.

Referring still to FIG. 7, according to the shown embodiment, WLAN-BT coexistence circuitry 713 may include logic providing an interface between the WLAN baseband circuitry 708a and the BT baseband circuitry 708b to enable use cases requiring WLAN and BT coexistence. In addition, a switch 703 may be provided between the WLAN FEM circuitry 704a and the BT FEM circuitry 704b to allow switching between the WLAN and BT radios according to application needs. In addition, although the antennas 701 are depicted as being respectively connected to the WLAN FEM circuitry 704a and the BT FEM circuitry 704b, embodiments include within their scope the sharing of one or more antennas as between the WLAN and BT FEMs, or the provision of more than one antenna connected to each of FEM 704a or 704b.

In some embodiments, the front-end module circuitry 704a-b, the radio IC circuitry 706a-b, and baseband processing circuitry 708a-b may be provided on a single radio card, such as wireless radio card 702. In some other embodiments, the one or more antennas 701, the FEM circuitry 704a-b and the radio IC circuitry 706a-b may be provided on a single radio card. In some other embodiments, the radio IC circuitry 706a-b and the baseband processing circuitry 708a-b may be provided on a single chip or integrated circuit (IC), such as IC 712.

In some embodiments, the wireless radio card 702 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.1lay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the BT baseband circuitry 708b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., SGPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

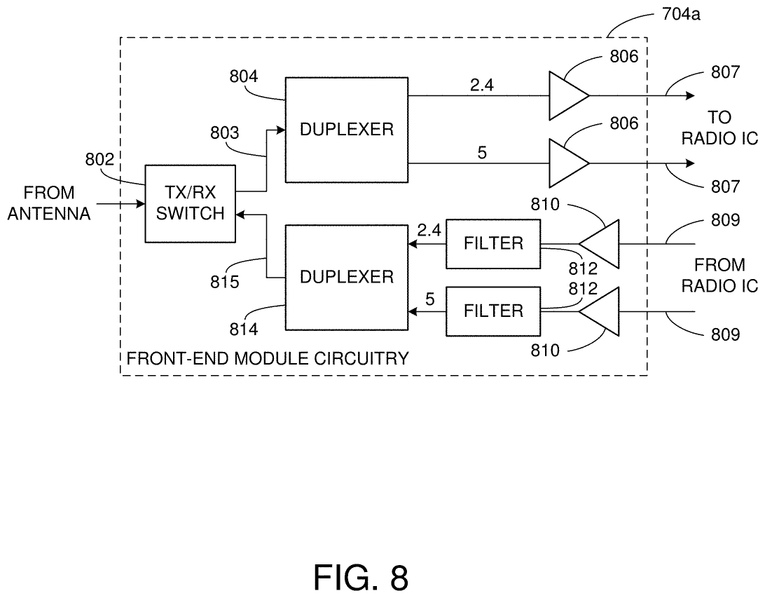

FIG. 8 illustrates WLAN FEM circuitry 704a in accordance with some embodiments. Although the example of FIG. 8 is described in conjunction with the WLAN FEM circuitry 704a, the example of FIG. 8 may be described in conjunction with the example BT FEM circuitry 704b (FIG. 7), although other circuitry configurations may also be suitable.

In some embodiments, the FEM circuitry 704a may include a TX/RX switch 802 to switch between transmit mode and receive mode operation. The FEM circuitry 704a may include a receive signal path and a transmit signal path. The receive signal path of the FEM circuitry 704a may include a low-noise amplifier (LNA) 806 to amplify received RF signals 803 and provide the amplified received RF signals 807 as an output (e.g., to the radio IC circuitry 706a-b (FIG. 7)). The transmit signal path of the circuitry 704a may include a power amplifier (PA) to amplify input RF signals 809 (e.g., provided by the radio IC circuitry 706a-b), and one or more filters 812, such as band-pass filters (BPFs), low-pass filters (LPFs) or other types of filters, to generate RF signals 815 for subsequent transmission (e.g., by one or more of the antennas 701 (FIG. 7)) via an example duplexer 814.

In some dual-mode embodiments for Wi-Fi communication, the FEM circuitry 704a may be configured to operate in either the 2.4 GHz frequency spectrum or the 5 GHz frequency spectrum. In these embodiments, the receive signal path of the FEM circuitry 704a may include a receive signal path duplexer 804 to separate the signals from each spectrum as well as provide a separate LNA 806 for each spectrum as shown. In these embodiments, the transmit signal path of the FEM circuitry 704a may also include a power amplifier 810 and a filter 812, such as a BPF, an LPF or another type of filter for each frequency spectrum and a transmit signal path duplexer 804 to provide the signals of one of the different spectrums onto a single transmit path for subsequent transmission by the one or more of the antennas 701 (FIG. 7). In some embodiments, BT communications may utilize the 2.4 GHz signal paths and may utilize the same FEM circuitry 704a as the one used for WLAN communications.

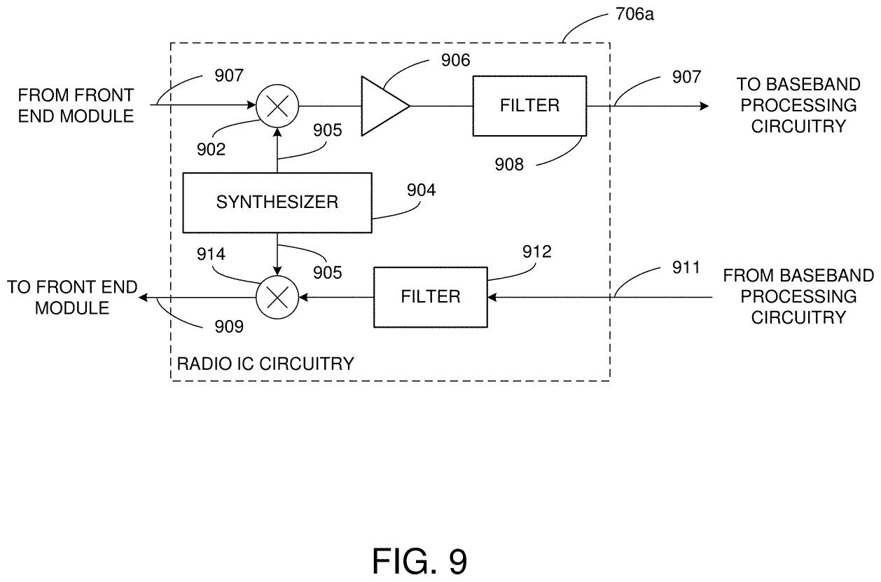

FIG. 9 illustrates radio IC circuitry 706a in accordance with some embodiments. The radio IC circuitry 706a is one example of circuitry that may be suitable for use as the WLAN or BT radio IC circuitry 706a/706b (FIG. 7), although other circuitry configurations may also be suitable. Alternatively, the example of FIG. 9 may be described in conjunction with the example BT radio IC circuitry 706b.

In some embodiments, the radio IC circuitry 706a may include a receive signal path and a transmit signal path. The receive signal path of the radio IC circuitry 706a may include at least mixer circuitry 902, such as, for example, down-conversion mixer circuitry, amplifier circuitry 906 and filter circuitry 908. The transmit signal path of the radio IC circuitry 706a may include at least filter circuitry 912 and mixer circuitry 914, such as, for example, up-conversion mixer circuitry. Radio IC circuitry 706a may also include synthesizer circuitry 904 for synthesizing a frequency 905 for use by the mixer circuitry 902 and the mixer circuitry 914. The mixer circuitry 902 and/or 914 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 9 illustrates only a simplified version of a radio IC circuitry, and may include, although not shown, embodiments where each of the depicted circuitries may include more than one component. For instance, mixer circuitry 914 may each include one or more mixers, and filter circuitries 908 and/or 912 may each include one or more filters, such as one or more BPFs and/or LPFs according to application needs. For example, when mixer circuitries are of the direct-conversion type, they may each include two or more mixers.

In some embodiments, mixer circuitry 902 may be configured to down-convert RF signals 807 received from the FEM circuitry 704a-b (FIG. 7) based on the synthesized frequency 905 provided by synthesizer circuitry 904. The amplifier circuitry 906 may be configured to amplify the down-converted signals and the filter circuitry 908 may include an LPF configured to remove unwanted signals from the down-converted signals to generate output baseband signals 907. Output baseband signals 907 may be provided to the baseband processing circuitry 708a-b (FIG. 7) for further processing. In some embodiments, the output baseband signals 907 may be zero-frequency baseband signals, although this is not a requirement. In some embodiments, mixer circuitry 902 may comprise passive mixers, although the scope of the embodiments is not limited in this respect.

In some embodiments, the mixer circuitry 914 may be configured to up-convert input baseband signals 911 based on the synthesized frequency 905 provided by the synthesizer circuitry 904 to generate RF output signals 809 for the FEM circuitry 704a-b. The baseband signals 911 may be provided by the baseband processing circuitry 708a-b and may be filtered by filter circuitry 912. The filter circuitry 912 may include an LPF or a BPF, although the scope of the embodiments is not limited in this respect.

In some embodiments, the mixer circuitry 902 and the mixer circuitry 914 may each include two or more mixers and may be arranged for quadrature down-conversion and/or up-conversion respectively with the help of synthesizer 904. In some embodiments, the mixer circuitry 902 and the mixer circuitry 914 may each include two or more mixers each configured for image rejection (e.g., Hartley image rejection). In some embodiments, the mixer circuitry 902 and the mixer circuitry 914 may be arranged for direct down-conversion and/or direct up-conversion, respectively. In some embodiments, the mixer circuitry 902 and the mixer circuitry 914 may be configured for super-heterodyne operation, although this is not a requirement.

Mixer circuitry 902 may comprise, according to one embodiment: quadrature passive mixers (e.g., for the in-phase (I) and quadrature phase (Q) paths). In such an embodiment, RF input signal 807 from FIG. 9 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 905 of synthesizer 904 (FIG. 9). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 807 (FIG. 8) may comprise a balanced signal, although the scope of the embodiments is not limited in this respect. The I and Q baseband output signals may be provided to low-noise amplifier, such as amplifier circuitry 906 (FIG. 9) or to filter circuitry 908 (FIG. 9).

In some embodiments, the output baseband signals 907 and the input baseband signals 911 may be analog baseband signals, although the scope of the embodiments is not limited in this respect. In some alternate embodiments, the output baseband signals 907 and the input baseband signals 911 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 904 may be a fractional-N synthesizer or a fractional N/N+1 synthesizer, although the scope of the embodiments is not limited in this respect as other types of frequency synthesizers may be suitable. For example, synthesizer circuitry 904 may be a delta-sigma synthesizer, a frequency multiplier, or a synthesizer comprising a phase-locked loop with a frequency divider. According to some embodiments, the synthesizer circuitry 904 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 904 may be provided by a voltage controlled oscillator (VCO), although that is not a requirement. A divider control input may further be provided by either the baseband processing circuitry 708a-b (FIG. 7) depending on the desired output frequency 905. In some embodiments, a divider control input (e.g., N) may be determined from a look-up table (e.g., within a Wi-Fi card) based on a channel number and a channel center frequency as determined or indicated by the example application processor 710. The application processor 710 may include, or otherwise be connected to, one of the example secure signal converter 101 or the example received signal converter 103 (e.g., depending on which device the example radio architecture is implemented in).

In some embodiments, synthesizer circuitry 904 may be configured to generate a carrier frequency as the output frequency 905, while in other embodiments, the output frequency 905 may be a fraction of the carrier frequency (e.g., one-half the carrier frequency, one-third the carrier frequency). In some embodiments, the output frequency 905 may be a LO frequency (fLO).

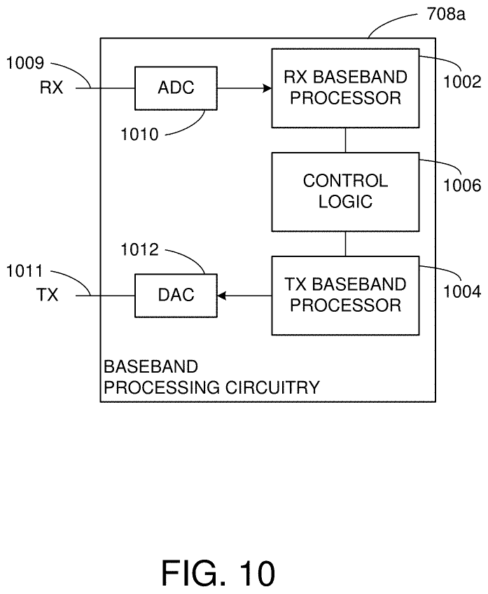

FIG. 10 illustrates a functional block diagram of baseband processing circuitry 708a in accordance with some embodiments. The baseband processing circuitry 708a is one example of circuitry that may be suitable for use as the baseband processing circuitry 708a (FIG. 7), although other circuitry configurations may also be suitable. Alternatively, the example of FIG. 9 may be used to implement the example BT baseband processing circuitry 708b of FIG. 7.

The baseband processing circuitry 708a may include a receive baseband processor (RX BBP) 1002 for processing receive baseband signals 909 provided by the radio IC circuitry 706a-b (FIG. 7) and a transmit baseband processor (TX BBP) 1004 for generating transmit baseband signals 911 for the radio IC circuitry 706a-b. The baseband processing circuitry 708a may also include control logic 1006 for coordinating the operations of the baseband processing circuitry 708a.

In some embodiments (e.g., when analog baseband signals are exchanged between the baseband processing circuitry 708a-b and the radio IC circuitry 706a-b), the baseband processing circuitry 708a may include ADC 1010 to convert analog baseband signals 1009 received from the radio IC circuitry 706a-b to digital baseband signals for processing by the RX BBP 1002. In these embodiments, the baseband processing circuitry 708a may also include DAC 1012 to convert digital baseband signals from the TX BBP 1004 to analog baseband signals 1011.

In some embodiments that communicate OFDM signals or OFDMA signals, such as through baseband processor 708a, the transmit baseband processor 1004 may be configured to generate OFDM or OFDMA signals as appropriate for transmission by performing an inverse fast Fourier transform (IFFT). The receive baseband processor 1002 may be configured to process received OFDM signals or OFDMA signals by performing an FFT. In some embodiments, the receive baseband processor 1002 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 7, in some embodiments, the antennas 701 (FIG. 7) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 701 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

What is claimed is:

1. A device, the device comprising storage coupled to processing circuitry, the processing circuitry configured to:
identify an ultrasound message received from a first device, wherein the ultrasound message includes a subset of characters or a subset of bits associated with a wireless connection;
determine, based on the subset of characters or the subset of bits, an identifier associated with the wireless connection;
determine, based on the ultrasound message, a password associated with the wireless connection; and
establish the wireless connection using the identifier and the password.

2. The device of claim 1, wherein the processing circuitry is further configured to cause to send an ultrasound request to the first device, and wherein the ultrasound message is received in response to the ultrasound request.

3. The device of claim 1, wherein the wireless connection is a Wi-Fi connection with an access point, and wherein to determine the identifier comprises the processing circuitry being further configured to:
determine a flag indicating the subset of characters;
determine, based on the flag, that the subset of characters comprises a subset of characters associated with a Wi-Fi service set identifier (SSID), a subset of characters associated with a Wi-Fi password, a subset of bits associated with a sum of all characters of the Wi-Fi SSID, or a Wi-Fi basic service set identifier (BSSID); and
determine, based on the subset of characters or the subset of bits, the identifier and the password, wherein to establish the wireless connection comprises the processing circuitry being further configured to establish a connection with the access point.

4. The device of claim 3, wherein the Wi-Fi connection is a Wi-Fi direct connection.

5. The device of claim 1, wherein the wireless connection is a Bluetooth connection with the first device, and wherein to determine the identifier comprises the processing circuitry being further configured to:
determine a flag indicating the subset of characters;
determine, based on the flag, that the subset of characters comprises a Bluetooth address associated with the first device; and
determine, based on the subset of characters, the identifier and the password, wherein to establish the wireless connection comprises the processing circuitry being further configured to establish a connection with the device.

6. The device of claim 1, wherein the processing circuitry is further configured to determine that the ultrasound message comprises a flag indicating that 94 characters are allowed for the identifier and the password, wherein the 94 characters use seven bits per character, wherein the 94 characters consist of lower case letters, upper case letters, symbols, and numbers, and wherein to determine the identifier is further based on the flag.

7. The device of claim 1, wherein the processing circuitry is further configured to determine that the ultrasound message comprises a flag indicating that 62 characters are allowed for the identifier and the password, wherein the 62 characters use six bits per character, wherein the 62 characters consist of lower case letters, upper case letters, and numbers, and wherein to determine the identifier is further based on the flag.

8. The device of claim 1, wherein the processing circuitry is further configured to determine that the ultrasound message comprises a flag indicating that 26 characters are allowed for the identifier and the password, wherein the 26 characters use five bits per character, wherein the 26 characters consist of lower case characters.

9. The device of claim 1, wherein the processing circuitry is further configured to determine that the ultrasound message comprises a flag indicating that 10 characters are allowed for the identifier and the password, and wherein the 10 characters consist of numbers, and wherein to determine the identifier is further based on the flag.

10. The device of claim 1, further comprising one or more transceivers configured to transmit and receive wireless signals, wherein the wireless signals comprise the ultrasound message and one or more messages associated with establishing the wireless connection.

11. The device of claim 10, further comprising one or more antennas coupled to the one or more transceivers.

12. A non-transitory computer-readable medium storing computer-executable instructions which when executed by one or more processors result in performing operations comprising:
determining, by a device, an identifier associated with a wireless connection, wherein the identifier comprises characters;
determining a subset of the characters;
generating an ultrasound message comprising a password associated with the wireless connection and an indication of the subset of the characters; and
causing to send the ultrasound message.

13. The non-transitory computer-readable medium of claim 12, wherein the device is a first device, the operations further comprising identifying an ultrasound request received from a second device, wherein generating the ultrasound message is based on receiving the ultrasound request.

14. The non-transitory computer-readable medium of claim 12, wherein the device is a first device, wherein the subset of the characters comprises a Bluetooth address associated with the first device, wherein generating the ultrasound message comprises generating a flag indicative of the Bluetooth address, and wherein the ultrasound message comprises the flag, and wherein the wireless connection is a Bluetooth connection, the operations further comprising establishing the Bluetooth connection with a second device based on the password.

15. The non-transitory computer-readable medium of claim 12, wherein the wireless connection is a Wi-Fi connection with an access point, wherein the subset of the characters comprises a subset of characters associated with a Wi-Fi service set identifier (SSID), a subset of bits associated with a sum of all characters of the Wi-Fi SSID, or a Wi-Fi basic service set identifier (BSSID), wherein generating the ultrasound message comprises generating a flag indicating the subset of the characters, and wherein the ultrasound messages comprises the flag.

16. The non-transitory computer-readable medium of claim 12, wherein generating the ultrasound message comprises generating a flag indicating a number of characters allowed for the identifier and the password, and wherein the ultrasound message comprises the flag.

17. The non-transitory computer-readable medium of claim 16, wherein the number of characters is 94, 62, 26, or 10, and wherein the number of characters is associated with less than eight bits per character.

18. A method comprising:
causing to send, by processing circuitry of a first device, an ultrasound request;
identifying, by the processing circuitry of the first device, an ultrasound response received from a second device;
determining, by the processing circuitry and based on the ultrasound request and the ultrasound response, a distance between the first device and the second device;
establishing a peer-to-peer connection with the second device based on the distance;
identifying an authentication request received from the second device using the peer-to-peer connection, wherein the authentication request comprises a Wi-Fi service set identifier (SSID); and
causing to send an authentication response to the second device using the peer-to-peer connection, wherein the authentication response comprises the Wi-Fi SSID and a password.

19. The method of claim 18, wherein the ultrasound response comprises a Bluetooth address associated with the first device and a Bluetooth password associated with the first device, and wherein establishing the peer-to-peer connection comprises establishing a Bluetooth connection based on the Bluetooth address and the Bluetooth password.

20. The method of claim 18, wherein determining the distance comprises:
determining a round trip time associated with the ultrasound request and the ultrasound response; and
determining, based on the round trip time, the distance, wherein establishing the peer-to-peer connection based on the distance comprises:
determining that the distance is less than a distance threshold; and
establishing a Bluetooth connection based on the distance being less than the distance threshold.
